(19) United States
(12) Patent Application Publication
(10) Pub. No.: US 2015/0345268 A1
(43) Pub. Date: Dec. 3, 2015

(54) APPLICATIONS OF ULTRA-LOW VISCOSITY FLUIDS TO STIMULATE ULTRA-TIGHT HYDROCARBON-BEARING FORMATIONS

(71) Applicant: STATOIL GULF SERVICES LLC, Houston, TX (US)

(72) Inventors: Jason BRYANT, Spring, TX (US); Endre IVARRUD, Katy, TX (US); Lionel RIBEIRO, Houston, TX (US); Huina LI, Houston, TX (US)

(73) Assignee: STATOIL GULF SERVICES LLC, Houston, TX (US)

(21) Appl. No.: 14/287,630

(22) Filed: May 27, 2014

(51) Int. Cl. E21B 43/16; C09K 8/594; C09K 8/80; C09K 8/70

(52) U.S. Cl. CPC E21B 43/164; C09K 8/70; C09K 8/594; C09K 8/80; C09K 8/805

(57) ABSTRACT

A method of recovering hydrocarbons from a hydrocarbon-bearing subterranean formation with a matrix permeability of less than 1 mD is disclosed. The method includes injecting a volume of a first fluid having a viscosity lower than the viscosity of water into an injection well present in the formation; separately injecting a volume of a second fluid into the formation before, after, or before and after injecting the first fluid; and producing at least a fraction of the injected volume of the first fluid and hydrocarbons from the formation through a production well present in the formation.

### BACKGROUND OF THE INVENTION

1. Field of the Invention

The present invention relates to applications of ultra-low viscosity fluids to stimulate ultra-tight hydrocarbon-bearing formations.

2. Description of Background Art

Over the years, enormous strides in various oil extraction and oil recovery (also referred to as “oil production”) methods have been achieved, ranging from improved oil recovery (“IOR”) methods, incorporating technologies such as water injection into subterranean oil-bearing formations, to enhanced oil recovery (“EOR”) methods, incorporating technologies such as gas injection into subterranean oil-bearing formations.

Mature EOR technologies include gas-injection-based methods, microbial-based methods, chemical-based methods, and thermal-based methods. Thermal methods and gas injection are the two most commonly applied EOR technologies commercially. Thermal methods include technologies such as Steam Assisted Gravity Drainage (SAGD) and Cyclic Steam Stimulation (CSS). Gas injection recovery processes include technologies such as CO₂ injection, nitrogen injection, and hydrocarbon gas injection. Gas injection processes often follow water injection processes, and in some cases water and gas injections are alternated to improve sweep efficiency and mitigate the effects of viscous fingering due to adverse mobility contrast between the gas and the in-situ oil, and gravity override due to density contrasts between the gas and the oil. Such processes are sometimes referred to as water alternating gas injection or WAG.

Attention has also been focused on water-assisted production methods, i.e. introducing “additives” to the injection water (changing the composition of the water) in order to improve or optimize the water flood efficiency. These enhanced oil recovery processes are referred to as chemical floods. Exemplary techniques include: alkali-surfactant-polymer flooding, polymer flooding, surfactant flooding, low-salinity water injection, and combinations thereof. In all these cases, the water composition is modified before injection. For instance, surfactants may be included to reduce interfacial tension between oil in order to mobilize residual oil after water-flooding. Polymer based gels may be added to block preferential water flow through high permeability (thief) zones.

In addition to improved oil recovery methods and enhanced oil recovery methods, other forms of technologies have been applied to improve the economics of oil recovery from challenged resources. Exemplary techniques include: horizontal drilling, artificial lift, and hydraulic fracturing. Horizontal drilling results in increased reservoir contact with the production well. Artificial lift is used to increase the drawdown in the reservoir, allowing the hydrocarbons to more readily flow to a production well. Similar to horizontal wells, hydraulic fracturing is used to create more surface area in close proximity to a high permeability channel in direct communication with a production well, allowing hydrocarbons to more readily flow to a production well. Hydraulic fracturing is typically a complex process, often with dozens of chemicals added to optimize proppant transport, proppant placement and settling, and wellbore flow. Often, high injection rates are required to fracture a subterranean formation effectively. These high rates result in substantial pressure drops through the well due to friction. In order to mitigate this pressure drop, friction reducing chemicals such as polyacrylamide or long-chain polymers are added to the fracturing fluid to mitigate turbulence in the well. Another challenge with hydraulic fracturing is effectively transporting and placing proppant. It is largely accepted that low viscosity fluids create more complex fracture networks with more effective connectivity to the formation, but these fluids cannot effectively transport or place proppant deep in the formation. Therefore, a number of other chemicals are added to the fracture water to assist in proppant transport. In this complex process, a variety of chemicals can be injected for various purposes including hydrochloric acid, sodium sulfate, sodium hydroxide, methanol, ethylene glycol monobutyl ether, alcohol ethoxylate, glutaraldehyde, ethanol, petroleum distillate, ammonium acetate, polyacrylamide, sorbitol tetraoleate, surfactants, etc. Gelling agents, crosslinkers, and/or breakers may also be added. Examples of gelling agents include guar, hydroxyethylguar, hydroxypropylguar, carboxymethyllguar, carboxymethylhydroxypropylguar, hydroxyethyl cellulose, carboxyethylcellulose, carboxymethylcellulose, carboxymethylhydroxyethylcellulose, xanthan, and diutan. Examples of crosslinkers include borate ions, zirconium IV ions, titanium IV like boric acid, zirconium lactate, zirconium citrate, titanium lactate, titanium malate, and titanium citrate. Examples of breakers include hydrogen peroxide, sodium persulfate, ammonium persulfate, sodium hypochlorite, and sodium chlorite.

In many subterranean formations, it is known that inducing and/or extending existing fractures and cracks in the subterranean formation improves the efficiency of extracting hydrocarbons. Fractures may extend several tens or even hundreds of meters from a main wellbore from which they originate.

As hydrocarbon-bearing formations are often disposed horizontally, in many cases, it is preferred to use horizontal drilling, and fracturing operations (inducing fractures in the formation) may be carried out on a single well. These operations may be accomplished by, for example, retracting open slots in a liner along the borehole. A common method to induce fractures is by hydraulic fracturing. In this case, a fluid is pumped into the formation via the wellbore at high pressures. The pressure can be up to around 600 bar. In some cases, the pressure can be even higher. The first fractures may be created by the use of explosive materials, and these are extended by the high pressure fluid. The most commonly used fracturing fluid is water with added chemicals and solid particles. Typically, the solids, termed proppants, make up 5-15 volume % of the fracturing fluid, chemicals make up 1-2 volume %, and the remainder is water. After the fracturing operation, fractures appear in the formation. Proppant particles remain in the fracture and help to hold the fracture open, for instance, when there is no more pressure from the fracturing fluid.

Other fracturing fluids besides water may include freshwater, saltwater, nitrogen, CO₂, and various types of hydrocarbons (e.g. alkanes such as propane or liquid petroleum gas (LPG), natural gas, other light-petroleum distillates, and diesel). The fracturing fluid may also include substances such as hydrogen peroxide, propellants (typically monopropellants), acids, bases, surfactants, alcohols and the like.

Considering the case where the fracturing fluid is LPG, in order for LPG gas to be suitable for use in fracturing of wells, it is necessary to form it into a gel so that, among other properties, it may transport proppants. A gel consistency is required to maintain a suitable proppant dispersion. An advantage of this technology is the simplicity in disposal of the fracturing fluid. After the fracturing operation, the LPG reverts from a gel to a gas and escapes the borehole during decompression, leaving proppants in the fractures in order to hold the fractures open and prevent them from closing. Furthermore, during the change from (gel-like) liquid to gas form, the LPG volume increases greatly, thereby increasing the pressure in the formation and further extending fractures. It is thought that recovered LPG gas is suitable for reuse. Compared to many other methods of hydraulic fracturing, the method based on LPG does not leave chemical substances in the soil and also reduces the effect of reflux.

The chemicals added may comprise viscosifier agents and/or cross-linked polymers, often from natural vegetation like cellulose, that enhance the fracturing fluid's ability to transport proppants into the fractures. Some chemicals also reduce the friction between the fracturing fluid being pumped and the well conduits. Examples of suitable gelling agents are hydroxypropyl guars (of ionic or non-ionic type) and polyacrylamides. The fracturing fluid may also be an emulsion created by mixing water with a liquid hydrocarbon. Another fracturing fluid option is to form a foam, which consists of a stable mixture of a liquid-like external phase and a gaseous-like internal phase, where the external phase is typically a gelled water-based fluid and the external phase is typically carbon dioxide or nitrogen. For fracturing applications, the internal phase commonly constitutes 70 to 80% of the total fluid volume. After a fracturing operation, the fracturing fluid is returned, at least in part, back to the surface for reuse or disposal. This operation creates issues with handling the added chemicals and also with handling large amounts of water (when the fracturing fluid is water-based). After the fracturing operation, the fracturing fluid normally includes bacteria and hydrogen sulfide, which need to be safely handled. Once the fracturing fluids have been removed, many proppant particles remain in the fractures in the subterranean formation.

The cost of proppant may be up to 10% of the drilling costs. A single well may require more than 2,000 tons of proppant. As described above, the function of the proppant is to assist in keeping the fractures open after fracturing when the pressure from the fracturing fluid is removed. Commonly used proppants are sand particles, consisting mainly of silica or quartz, or ceramic particles (e.g., titania or α-alumina made by heating loam, clay, kaolin or bauxite, the latter to temperatures above 1100° C.). Proppants may be coated particles, in which case the particles contain a thin outer layer of a polymer resin that help in reducing the drag forces during production and to make the surface hydrophobic to prevent blocking by adsorbed water. The coating prevents agglomeration of the proppant particles and improves dispersion in the fracturing fluid. Further, resin coated proppants may reduce proppant flow-back, lower the propensity for cracking the proppant and generating fines that plug the proppant pack, and improve stress resistance.

The industry is also looking into recovering oil from geologic landscapes that formerly were economically challenged. For instance, ultra-tight permeability reservoirs often referred to as shale reservoirs. These reservoirs can contain hydrocarbons in the oil phase, gas phase, or both phases. The hydrocarbons in these reservoirs may or may not actually be contained in shales. In some cases, they are simply contained in very low permeability carbonates, siliciclastics, or combinations thereof. A common attribute among this reservoir class is how they are typically developed. Many ultra-tight systems or shale reservoirs are economically developed using techniques such as horizontal wells and hydraulic fracturing to increase contact of the well with the formation The Bakken formation is one example of such an ultra-tight reservoir or subterranean hydrocarbon bearing formation.

Hydrocarbons that can benefit from heat treatment are typically high viscosity or low mobility hydrocarbons such as bitumen, e.g. in oil sands, heavy oil, extra heavy oil, tight oil, kerogen and coal. Oils are often classified by their API gravity, and a gravity below 22.3° is regarded as heavy, and below 10.0° API as extra heavy. Bitumen is typically around 8° API.

Shale reservoirs are hydrocarbon reservoirs formed in a shale formation, often denoted as shale oil, shale gas, or oil shale. Extracting hydrocarbons from shale reservoirs can be difficult because the shale formation is of low porosity and low permeability, so fluid hydrocarbons may not be able to find a path through the formation towards a production well. As such, when a well is drilled into the formation, only those fluid hydrocarbons in proximity to the well are produced, as the other hydrocarbons farther away from the well have no easy path to the well through the relatively impermeable rock formation. In order to improve hydrocarbon recovery from shale formations, the shale around the well is often hydraulically fractured. This operation involves propagating fractures through the shale formation using a pressurized fluid to create conduits in the impermeable shale formation. Hydrocarbon fluids can then migrate through the conduits toward the production well. In this way, recovery of hydrocarbons from the reservoir is improved because hydrocarbons that would not previously be able to reach the well in a reasonable time (i.e., several years) now have a path to the well and can be produced.

The term “oil shale” refers to a sedimentary rock interspersed with an organic mixture of complex chemical compounds collectively referred to as “kerogen.” The oil shale consists of laminated sedimentary rock containing mainly clay minerals, quartz, calcite, dolomite, and iron compounds. Oil shale can vary in its mineral and chemical composition. When the oil shale is heated to above 260-370° C., destructive distillation of the kerogen (a process known as pyrolysis) occurs to produce products in the form of oil, gas, and residual carbon. The hydrocarbon products resulting from the destructive distillation of the kerogen have uses that are similar to other petroleum products. Oil shale is considered to have the potential to become one of the primary sources for producing liquid fuels and natural gas and to supplement and augment those fuels currently produced from other petroleum sources. The use of resin coated proppants is incompatible with the temperatures required for kerogen pyrolysis.

Known in situ processes for recovering hydrocarbon products from oil shale resources intend to treat the oil shale in the ground in order to recover the hydrocarbon products. These processes involve the circulation or injection of heat and/or solvents within a subsurface oil shale. Heating methods include hot gas injection (e.g., flue gas or methane or superheated steam, hot liquid injection, electric resistive heating, dielectric heating, microwave heating, or oxidant injection) to support in situ combustion. Permeability enhancing methods are sometimes utilized including rubblization, hydraulic fracturing, explosive fracturing, heat fracturing, steam fracturing, and/or the provision of multiple wellbores.

A typical size of the proppant particles is a diameter of around 0.5 to 2 mm. It is preferred that each particle is approximately spherical and that the size distribution of the particles is reasonably uniform to enable easy flow of the particles. The compressive strength of the particles must be very high (i.e, several thousands of psi) in order for them to keep fractures open without being crushed. There may be a trade-off between the porosity and weight of a proppant particle and its resistance to compressive strength. A proppant particle must have sufficient compressive strength to reduce the likelihood of it being crushed by a fracture attempting to close when the fracturing fluid is no longer providing pressure in the fractured formation. For some applications of proppants in hydrocarbon production, the proppant must be resistant towards dissolution in acid environments. Acids like HF and/or HCl might be added to dissolve plugs in carbonaceous reservoirs. Furthermore, flow of hard proppants may cause erosion to pipes, production equipment and to the rock itself. In addition, the propensity to settling in the fracturing fluid should be minimized (e.g., by making the proppant sufficiently light in weight).

Oil production rates from such reservoirs under primary depletion often dramatically decline, resulting in oil rates that are only a small fraction of the initial production rates in a relatively short time. In many cases, rates can drop to much less than 10% of the initial production rate within two to three years. Oil recovery is further impeded by large water cuts (that is, the ratio of water produced in comparison to the total volume of liquids produced) during primary depletion, which can range upwards of 80% in some cases.

For conventional reservoirs (with a matrix permeability greater than 1 mD), crosslinked gel systems are used for fluid loss control, fracture generation, and proppant transport. A linear gel or crosslinked gel may be used in the beginning of the treatment to minimize fluid loss and increase fracture width.

The disadvantages of these gelled fluid systems include high pipe friction if gelling is not delayed, excessive formation damage if the breaking of macromolecules is not adequate, a limited rate and pressure can be applied to the formation, and only a limited stimulated reservoir area is covered compared to slickwater systems. In addition, complicated chemistry designs are required. The gelled fluids also have a high viscosity wherein low-shear rate viscosities are usually greater than 100 cP and can be greater than 1,000 cP and high-shear rate viscosities are usually greater than 10 cP and can be hundreds of centipoise. The gelled fluid may be aqueous-based, hydrocarbon-based, or in the form of foams or emulsions. In addition to the disadvantages of gelled fluids discussed above, the foams and emulsions can be expensive and usually have a high friction pressure compared to other gelled fluids and slickwater. Foams and emulsions are primarily used for under-pressured reservoirs (i.e., mature fields where pore pressure gradients are less than 0.433 psi/ft.)

For unconventional reservoirs (with a matrix permeability of less than 1 mD), slickwater or hybrid gel systems are used. In one example of a hybrid gel system, in the first part of the treatment fracture water (i.e., slickwater) or linear gel is used to generate complexity in the fracture network. In the last part of the treatment, linear gel or crosslinked gel is used to generate fracture width and transport proppant. Water-based systems are used in these systems. The slickwater volume can be 15-80%, and proppant can be pumped with both the slickwater and gelled fluid portions of the treatment. With the hybrid gel treatment, a large surface area of unpropped fractures is generated and appreciably contributes to the well production.

The disadvantages of slickwater include poor proppant suspension and transport compared to gelled fluids, limited fracture conductivity generation, and formation damage due to deposition of macromolecules. The disadvantages of the hybrid gel systems include the same inherent formation and fracture conductivity disadvantages as with gelled fluid and slickwater. Hybrid gel systems are designed to optimize the balance between reservoir area content (with the slickwater) and wide conductive, propped fractures (with the gelled fluid). However, the hybrid gel system will have limited proppant suspension and transport with the slickwater portion of the treatment and will have limited producible stimulated reservoir area with the gelled fluid portion of the treatment.

Another stimulation technique involves the use of non-aqueous fluids such as nitrogen, carbon dioxide, and hydrocarbons (e.g., gelled diesel, gelled crude oil, gelled light-petroleum distillates, or gelled LPG) as fracturing fluids. These fluids are applied to reservoirs where water-sensitivity adversely impacts production and where aqueous fluids may cause significant (and sometimes irreversible) formation damage (e.g., coal bed methane formations or any formations with appreciable swelling clays). Specifically, pure CO₂ and N₂ treatments have been pumped in tight gas sandstones and coal bed methane where clay swelling from aqueous fluids may significantly impair formation permeability. However, pure CO₂ and N₂ cannot carry proppant effectively and near well bore conductivity could be compromised. In addition, non-aqueous fluids (particularly nitrogen and carbon dioxide) may be applied to a limited subset of reservoir types due to costs, relatively high matrix leakoff, and relatively poor proppant transport.

Though oil recovery from unconventional reservoirs is economical today, a number of challenges (e.g., fast decline rates and low ultimate recoveries) restricting the full potential of these reservoirs still exist. While the hybrid stimulation methods used today with aqueous systems (in comparison to crosslinked fluid systems typically used in conventional reservoirs) did help increase fracture surface area and partially overcome deficiencies related to the low matrix permeability, access to the bulk of the reservoir (i.e., producible stimulated reservoir area) is still very limited using these methods for two primary reasons. The first reason is the lack of stimulated area per volume of reservoir (i.e, limited number of stimulated fractures per volume of reservoir), and the second reason is restricted flow paths in un-propped, fractured reservoirs due to water damage. Water-based fluids may also damage narrow fractured pathways due to clay swelling and fines migration, interfacial tension with reservoir hydrocarbons, and gelling agents used in the stimulation fluids.

Therefore, there is an industry-wide need for a method of more accurately identifying suitable methods for recovering oil from unconventional reservoirs, and new systems and compositions which maximize the recovery from these formerly challenged reservoirs.

### SUMMARY OF THE INVENTION

The first embodiment of the present invention is directed to a method of recovering hydrocarbons from a hydrocarbon-bearing subterranean formation with a matrix permeability of less than 1 mD or less than 0.1 mD, comprising injecting a volume of a first fluid having a viscosity lower than the viscosity of water into an injection well present in the formation; separately injecting a volume of a second fluid into the formation before, after, or before and after injecting the first fluid; and producing at least a fraction of the injected volume of the first fluid and hydrocarbons from the formation through a production well present in the formation. The first fluid may be pure or substantially pure carbon dioxide. The method may also comprise flushing the formation with the first fluid after the second fluid is injected. The second fluid may carry proppant. The first fluid may also carry proppant of 100 mesh or smaller. The proppant may be at least one of nut shells, resin-coated nut shells, graded sand, resin-coated sand, sintered bauxite, particulate ceramic materials, glass beads, or particulate polymeric materials. The second fluid may be a gelled aqueous fluid, foam, or emulsion. The method may also comprise fracturing a portion of the hydrocarbon-bearing subterranean formation. The method may also comprise the step of permitting the injected volume of the first fluid to reside for a period of time in the formation before said at least a fraction of the injected volume of the first fluid and the hydrocarbons are produced from the formation. The steps of injecting may be cyclic or continuous. The injected volume of the first fluid may be injected continuously into a first injection well in fluid communication with the formation, and then, hydrocarbons may be produced from a second production well in fluid communication with the formation. The volume of fluid for each injection may be 1 to 100,000 barrels.

The second embodiment of the present invention is directed to a fracturing fluid, comprising a first fluid having a viscosity lower than the viscosity of water; and a second fluid. The fracturing fluid is formed after the first fluid and the second fluid have been separately injected into a hydrocarbon-bearing subterranean formation with a matrix permeability of less than 1 mD. The first fluid may be pure or substantially pure carbon dioxide. The second fluid may be a gelled aqueous fluid, foam, or emulsion.

The third embodiment of the present invention is directed to a method of restimulating a hydrocarbon-bearing subterranean formation with a matrix permeability of less than 1 mD, comprising injecting a volume of a first fluid having a viscosity lower than the viscosity of water into an injection well present in the formation; separately injecting a second fluid into the formation before, after, or before and after injecting the first fluid; and producing at least a fraction of the injected volume of the first fluid and hydrocarbons from the formation through a production well present in the formation. The first fluid may be pure or substantially pure carbon dioxide. Restimulating the hydrocarbon-bearing subterranean formation may comprise fracturing a portion of the hydrocarbon-bearing subterranean formation. The hydrocarbon-bearing subterranean formation may have a matrix permeability of less than 0.1 mD. The volume of fluid for each injection may be 1 to 100,000 barrels.

The fourth embodiment of the present invention is directed to a hydrocarbon recovery system, comprising: a well connected to a hydrocarbon-bearing subterranean formation with a matrix permeability of less than 1 mD or less than 0.1 mD; an injection apparatus connected to said well; at least two storage containers in fluid communication with the injection apparatus; wherein said at least one storage container contains a volume of a first fluid having a viscosity lower than the viscosity of water; wherein said at least one storage container further contains a separate storage container containing a second fluid; and at least one valve that only allows one fluid to be injected into said well at a time. The hydrocarbon recovery system may also include a second well in fluid communication with the formation for recovering hydrocarbons from the formation. The first fluid may be pure or substantially pure carbon dioxide.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to one of ordinary skill in the art from this detailed description.

### BRIEF DESCRIPTION OF THE DRAWINGS

The present invention will become more fully understood from the detailed description given below and the accompanying drawings that are given by way of illustration only and are thus not limitative of the present invention.

FIG. 1 is an illustration to explain tight to ultra-tight hydrocarbon-bearing subterranean formations.

FIG. 2 is a diagrammatic view of an example of a hydrocarbon-bearing subterranean formation to which the present invention is applicable.

FIG. 3 is a graph of a discrete fracture network used in a simulation to determine the effectiveness of different fluids.

FIG. 4 is a graph of a stimulated surface area from fractures with transmissivity of at least 2 mD-ft (6×10⁻¹⁶ m³) for each of the fluids after the simulation was run.

FIG. 5 is a graph showing the stimulated surface area from fractures with transmissivity of at least 2 mD-ft (6×10⁻¹⁶ m³) at 120 minutes (20 minutes of pumping and 100 minutes of shut-in) for each of the fluids after the simulation was run.

### DETAILED DESCRIPTION OF THE INVENTION

The present invention will now be described with reference to the accompanying drawings.

The present invention is directed to methods of recovering hydrocarbons from a hydrocarbon-bearing formation with a matrix permeability of less than 1 mD.

In this regard, a manner of identifying the potential success of oil recovery from subterranean formations is to characterize the permeability characteristics of the formation. Permeability is a measurement of the resistance to fluid flow of a particular fluid through the reservoir and is dependent on the structure, connectivity, and material properties of the pores in a subterranean formation. Permeability can differ in different directions and in different regions.

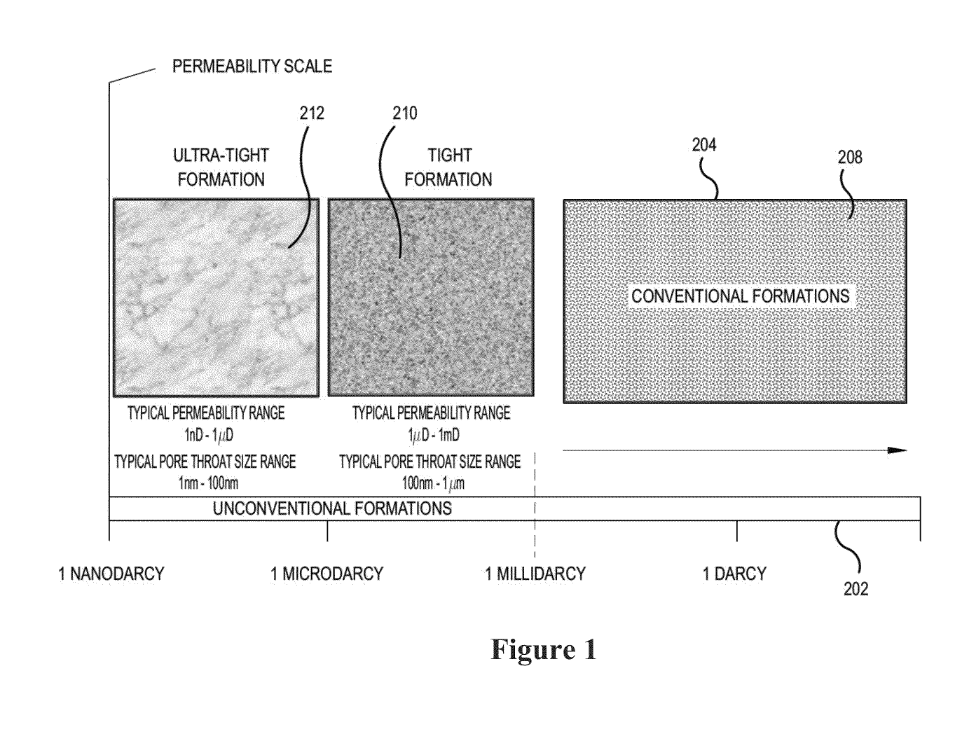

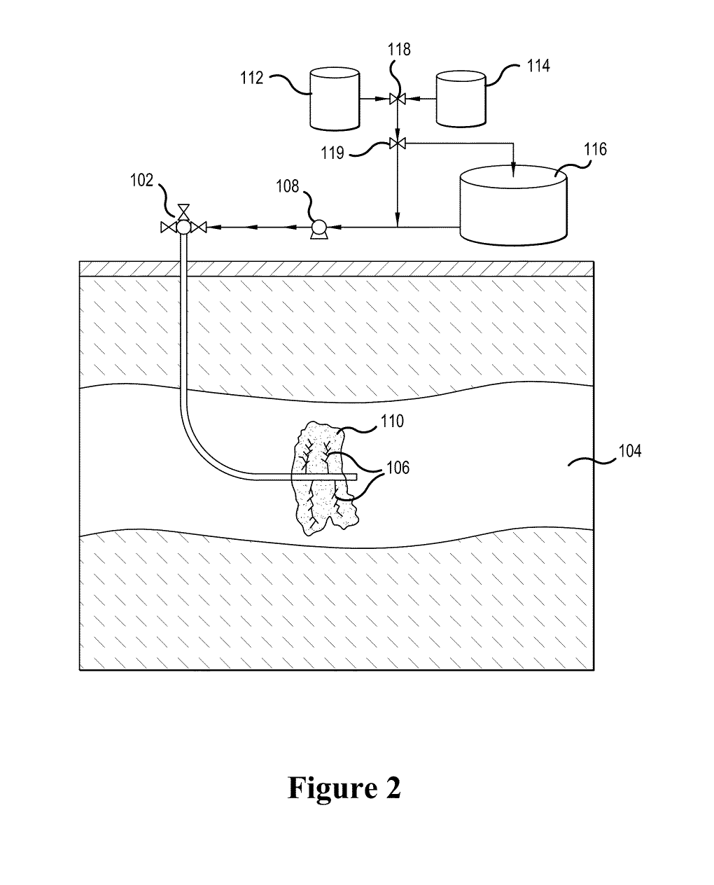

FIG. 1 is an example of a tight to ultra-tight hydrocarbon-bearing subterranean formation 104 as depicted in FIG. 2. A tight to ultra-tight formation is characterized in terms of permeability or permeability scale 202. In a conventional formation 204, the pore throat sizes are relatively large such that, when the pores are highly interconnected 208, the formation is conducive to the flow of hydrocarbons. A conventional formation 204 will have a relatively high permeability as compared to tight formations 210 or ultra-tight formations 212. Both tight and ultra-tight formations are also known as unconventional formations.

Permeability can be defined using Darcy's law and can often carry units of m², Darcy (D), or milliDarcys (mD). Generally, a reservoir rock in a conventional formation 204 can have a permeability ranging from 1 mD to greater than 1,000 mD. A tight formation 210 often can have rock with typical permeability in the range of 1 μD to 1 mD, and an ultra-tight formation 212 can often have rock with typical permeability of 1 nD to 1 μD. Some reservoirs have regions of ultra-tight permeability, where the local permeability may be less than 1 μD, while the overall average permeability for the reservoir may be between 1 μD and 1 mD. Some reservoirs may have regions of ultra-tight or tight permeability with typical permeability of less than 1 mD in a majority of the formation but regions of the formation with high permeability greater than 1 mD and even greater than 1 D, particularly in the case of reservoirs with natural fractures. In the present invention, a hydrocarbon-bearing subterranean formation with a matrix permeability of less than a stated value means a formation with at least 90% of the formation having an unstimulated well test permeability below that stated value. However, at least 95%, at least 97%, at least 98%, or at least 99% of the formation may have an unstimulated well test permeability below that stated value. The present invention is applicable to hydrocarbon-bearing subterranean formations having a matrix permeability of less than 1 mD, but the formation may have a matrix permeability of less than 0.1 mD or less than 1 μD.

As discussed above, the present invention is applicable to hydrocarbon-bearing subterranean formations having a specific matrix permeability. However, the hydrocarbon-bearing subterranean formation can also be defined by the pressure in the reservoir. In an under-pressured reservoir, the pore pressure gradients are less than 0.433 psi/ft. In an over-pressured reservoir, the pore pressure gradients are greater than 0.433 psi/ft. The present invention is applicable to over-pressured reservoirs. A reservoir with pore pressure gradients greater than a stated value means a reservoir with at least 90% of the reservoir having pore pressure gradients greater than the stated value. However, at least 95%, at least 97%, at least 98%, or at least 99% of the reservoir may have pore pressure gradients greater than the stated value. The present invention is applicable to over-pressured reservoirs having pore pressure gradients greater than 0.433 psi/ft, but the reservoir may have pore pressure gradients greater than 0.6 psi/ft or greater than 0.8 psi/ft. In addition, the present invention can be applied to reservoirs where both stimulated surface area and near-wellbore conductivity is required for optimum production enhancement.

Fracturing techniques may be used to provide a means to increasing the injectivity of a formation when the reservoir has low permeability characteristics. Fracturing techniques may also be used as a means of injecting fluid when the reservoir has low permeability characteristics.

The term “fracturing” refers to the process and methods of breaking down a hydrocarbon-bearing subterranean formation and creating a fracture (i.e., the rock formation around a well bore) by pumping fluid at very high pressures in order to increase production rates from a hydrocarbon-bearing subterranean formation. Except with respect to the differences discussed herein, the fracturing methods otherwise use conventional techniques known in the art.

The present fracturing fluids and methods increase the ability to produce hydrocarbons from a subterranean formation even when fracturing had been previously performed. Thus, the present methods increase the ability to extract hydrocarbons after other methods of recovery are performed on a reservoir.

One embodiment of the present invention is directed to a method of recovering hydrocarbons from a hydrocarbon-bearing subterranean formation with a matrix permeability of less than 1 mD. FIG. 2 is an example of a hydrocarbon recovery system comprising a well 102 connected to the formation 104, an injection apparatus 108 connected to the well, and at least two storage containers 112, 114 in fluid communication with the injection apparatus 108. In this embodiment, a well 102 may be drilled in a hydrocarbon-bearing subterranean formation 104 with a matrix permeability of less than 1 mD, less than 0.1 mD, or less than 1 μD. In another embodiment, an existing well 102 can be utilized in a method for restimulating a hydrocarbon-bearing subterranean formation 104 with a matrix permeability of less than 1 mD, less than 0.1 mD, or less than 1 μD. The well 102 can be a single well, operational as both an injection and production well, or alternatively, the well can be distinct injection and production wells. The well 102 may be conventional or directionally drilled, thereby reaching the formation 104, as is well known to one of ordinary skill in the art.

The formation 104 can be hydraulically stimulated by injecting a fluid having a viscosity lower than the viscosity of water (hereinafter, may be referred to as “ultra-low viscosity fluid” or “first fluid”) into the formation in order to create fractures 106 in the formation 104. During injection, or during a cyclic injection phase, the production of hydrocarbons is stimulated by injecting via an injection apparatus 108 a volume of the ultra-low viscosity fluid through the well 102 and into an influence zone 110. The ultra-low viscosity fluid is contained in the storage container 112. After injecting the ultra-low viscosity fluid, the method may further include injecting a conventional fluid (also may be referred to as a “second fluid”) into the formation 104. The conventional fluid is contained in the storage container 114. The hydrocarbon recovery system also includes at least one valve 118 that only allows one fluid from storage container 112 or 114 to be injected into the well 102 at a time. For example, the valve 118 may be a valve wherein one opening is closed to prevent one fluid from storage container 112 or 114 from entering the injection apparatus 108 when the other fluid from storage container 112 or 114 is entering the injection apparatus 108. In other words, the valve 118 helps ensure that the first fluid and the second fluid are injected separately rather than simultaneously. If desired, the ultra-low viscosity fluid and/or conventional fluid can optionally first enter the proppant blender 116 to supply the ultra-low viscosity fluid and/or conventional fluid with proppant. After passing through the valve 118, the fluid then passes through a valve 119. The valve 119 allows the fluid to go fully to the blender 116, by-pass the blender 116, or simultaneously flow to the blender 116 and by-pass the blender 116 at the full range of ratios. The ultra-low viscosity fluid and the conventional fluid are injected into the formation 104 by way of a well bore. The volume of the ultra-low viscosity fluid may be 15-80% of the total fluid volume injected into the formation. Preferably, the volume of the ultra-low viscosity fluid may be 30-60% of the total fluid volume injected into the formation.

The conventional fluid may be any of the fluids described above wherein the conventional fluid is different from the ultra-low viscosity fluid. For example, the conventional fluid could be a fluid with a viscosity higher than water. Preferably, the conventional fluid has adequate viscosity to transport proppant. Specifically, the conventional fluid can be slickwater, gelled fluid, foams, and/or emulsions. Preferably, the conventional fluid is a gelled aqueous fluid or foam.

As described above, the ultra-low viscosity fluid is injected first and then the conventional fluid is injected. However, the conventional fluid may be injected before and/or after the ultra-low viscosity fluid. The volume of fluid for each injection can range from 1 to 100,000 (petroleum) barrels, preferably 10 to 10,000 barrels, each (petroleum) barrel being 42 gallons.

The optionally added proppant may be present with a proppant concentration in the ultra-low viscosity fluid and/or the conventional fluid that is not particularly limited. However, the optional proppant concentration can be 0 to 30 pounds per 1,000 gallons of fluid.

The viscosity is based on a measurement taken at room temperature at surface level. The viscosity of water at room temperature at surface level is 0.9 centipoise. Viscosity of any fluid will decrease in the subterranean formation. The fluid having a viscosity lower than the viscosity of water has a viscosity less than the viscosity of water at room temperature at surface level, preferably less than 0.8 centipoise, more preferably less than 0.5 centipoise, even more preferably 0.2 centipoise or less, and most preferably less than 0.1 centipoise. The ultra-low viscosity fluid may be one or more of pure or substantially pure carbon dioxide, hydrogen, nitrogen, alkanes, or other light-petroleum distillates. For instance, carbon dioxide may be injected as a liquid or a supercritical fluid. The alkanes may be methane, ethane, propane, or butane.

Once the ultra-low viscosity fluid and/or conventional fluid is injected into the formation, the well can be shut in for a period of time sufficient to achieve the desired goal of increasing fractures in the formation. The time may be less than four hours but may extend beyond several weeks. Once the ultra-low viscosity fluid and/or conventional fluid has achieved its objective, it is partially recovered from the formation together with any material dissolved. For example, the ultra-low viscosity fluid and/or conventional fluid may be recovered by holding back pressure on the reservoir (e.g., surface choke) and producing the fluid back, leaving any optional proppants in the formation. The choke size will depend on the amount of fluid being produced back and also the amount of back pressure needed to keep the fluid producing. The ultra-low viscosity fluid and/or conventional fluid may also be recovered by swabbing, gas assist, jetting, or allowing reservoir pressure to produce the injected fluids. The fluids can be recovered in a relatively short period of time.

More specifically, one embodiment of the present invention is a method of recovering hydrocarbons from a hydrocarbon-bearing subterranean formation with a matrix permeability of less than 1 mD. The formation may have a matrix permeability of less than 0.1 mD or less than 1 μD. The method involves injecting a fluid having a viscosity lower than the viscosity of water into the formation. The method may also include injecting a conventional fluid into the formation before and/or after injecting the ultra-low viscosity fluid. The conventional fluid may optionally carry proppant. The ultra-low viscosity fluid may also optionally carry proppant. The method may also include flushing the formation with the ultra-low viscosity fluid after the conventional fluid is injected. This method involves recovering hydrocarbons by fracturing a portion of the hydrocarbon-bearing subterranean formation. In other words, the method involves producing at least a fraction of the injected volume of fluid and hydrocarbons from the stimulated well.

A proppant is a natural or synthetic material that prop open a fracture after the fracture is created. The proppant may be any proppant material, including, but not limited to nut shells, resin-coated nut shells, graded sand, resin-coated sand, sintered bauxite, particulate ceramic materials, glass beads, particulate polymeric materials, and mixtures thereof.

If the first fluid carries proppant, the proppant may be 200 mesh or smaller, preferably 100 mesh or smaller.

Another embodiment of the present invention is directed to a method of restimulating a hydrocarbon-bearing subterranean formation with a matrix permeability of less than 1 mD, less than 0.1 mD, or less than 1 μD. The method of restimulating a formation is the same as the method for recovering hydrocarbons from a formation as described above. However, in this case, conventional techniques have already been applied to the formation, and further production is difficult or uneconomical. As such, this method allows for recovery of hydrocarbons in the formation, which were previously too difficult or costly to recover. In fact, less than 10-20% of the hydrocarbons may have been retrieved from some formations thus allowing for additional recovery using the present methods.

Another embodiment of the present invention is directed to a fracturing fluid that includes a fluid having a viscosity lower than the viscosity of water and a conventional fluid. The fracturing fluid is formed after the ultra-low viscosity fluid and the conventional fluid have been separately injected into a hydrocarbon-bearing subterranean formation with a matrix permeability of less than 1 mD, less than 0.1 mD, or less than 1 μD. This fracturing fluid significantly reduces the need for fresh water and significantly improves production in terms of initial production, a one-year cumulative total, and beyond. For example, the fracturing fluid leads to a greater than 25% increase in initial production and one-year cumulative total over conventional fracturing fluids. In addition, water usage is reduced by 30 to 90% on a volume basis.

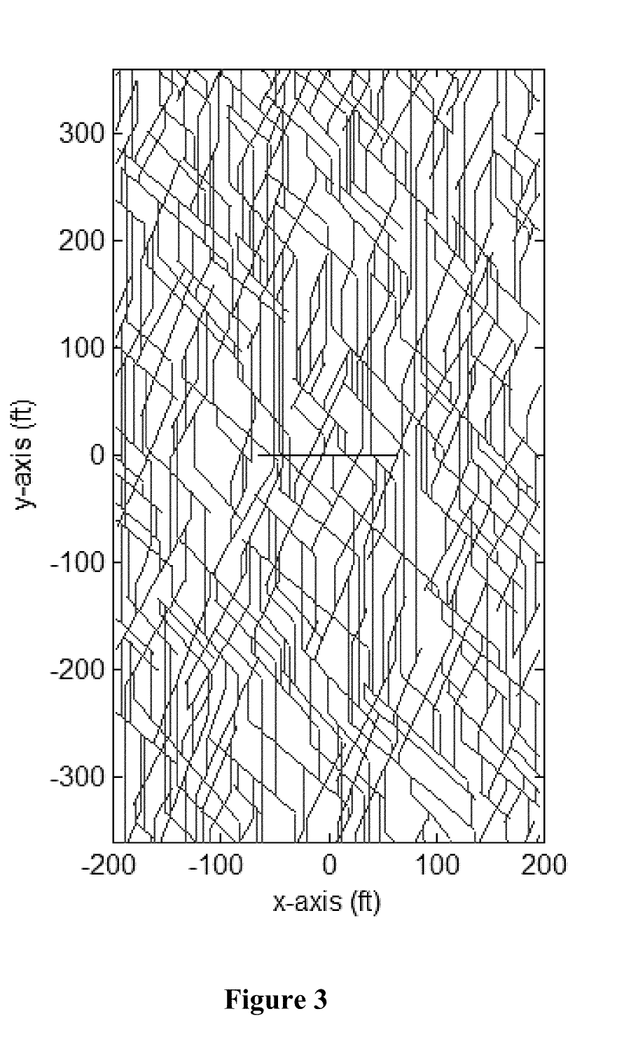

The fluid having a viscosity lower than the viscosity of water can generate more fracture area per volume of reservoir and per volume of fluid pumped than conventional systems. Specifically, FIGS. 3-5 provide simulation test results that compare the fracture area achieved using ultra-low viscosity fluid versus conventional fluids with higher viscosities. The simulations were performed using CFRAC, developed by Dr. Mark McClure and Roland Horne. See (1) McClure, M. W., and R. N. Horne 2013. Discrete Fracture Network Modeling of Hydraulic Stimulation: Coupling Flow and Geomechanics, Springer, doi:10.1007/978-3-319-00383-2 and (2) McClure, M. W. 2012. Modeling and characterization of hydraulic stimulation and induced seismicity in geothermal and shale gas reservoirs, PhD Thesis, Stanford University, Stanford, Calif. CFRAC is a simulator that couples fluid flow and deformation in 2D discrete fracture networks. Fracture elements are allowed to slide or open, and the stresses induced by deformation are calculated using the boundary element method.

The simulation cannot propagate fractures outside of the prescribed network of pre-existing natural fractures (NFs) and potentially forming hydraulic fractures (HFs). The potentially forming HFs are pre-defined paths along which fractures can grow. The initial conductivity and aperture of these potential paths is zero before being contacted by fluid pressure; therefore, a high density of potentially forming fractures provides more flexibility to capture fracture complexity. Initially, the natural fractures have a low transmissivity, but their transmissivity could increase, non-linearly, with cumulative sliding displacement, decreasing effective normal stress, and fracture opening. The matrix permeability is zero; therefore, there is no leak-off into the rock matrix, which is a reasonable assumption for ultra-tight formations. There is no proppant transport. For the flow and reservoir properties, injection is at 20 barrels/min for 20 minutes, followed by 100 min of well shut-in; far-field principal stresses are 8250 psi and 8000 psi in the y- and x-directions, respectively; pore pressure is 6800 psi; fracture height is constrained to 200 ft.; shear modulus is 2.2×10⁶ psi; Poisson's ratio is 0.25; and the coefficient of friction is 0.6. For the Discrete Fracture Network (DFN), additional inputs include: E₀=1 mm, e₀=30 μm, and K_{1c,NF}=800 psi-ft^{1/2}; where E₀ is the NF storage aperture, e₀ is the NF hydraulic aperture, and K_{1c,NF} is the toughness of the NFs.

In the simulation, a fracture that is “potentially producible” is defined as a fracture with conductivity of at least 2 mD-ft (6×10⁻¹⁶ m³) when plotting the surface area created versus time. This value is an arbitrary value that is used to evaluate the extent of the fracture network stimulated by the fracturing fluid.

The fractures were constrained to propagate along pre-existing NFs (i.e. joints, cracks, or any other unconformities) and/or potentially forming HFs. Generating multiple paths for HF propagation allow fractures to follow the path of least resistance. The DFN used is provided in FIG. 3.

The minimum horizontal stress is aligned with the x-axis and the maximum horizontal stress is aligned with the y-axis. The segment in the center of FIG. 3 aligned parallel to the minimum horizontal stress direction represents an open-hole section of the wellbore of 130 ft. The NFs were generated with two dominant orientations shown on FIG. 3. The two sets of predominantly aligned NFs are represented by the segments that do not align with either principal stress direction. The NF average length is 80 feet, and their reference hydraulic aperture is 50 μm. In addition, the “potentially forming” HFs are the segments that are orthogonal to the minimum far-field principal stress.

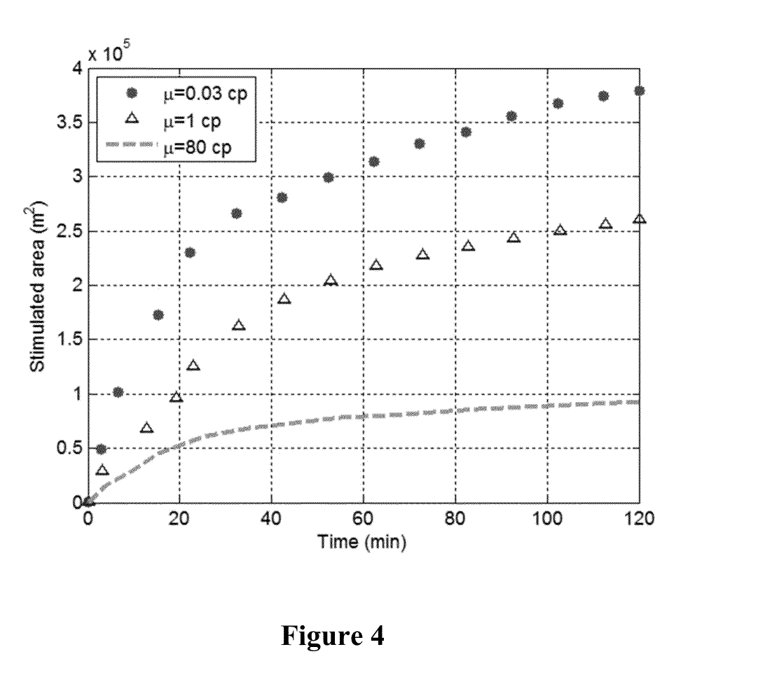

The use of a low-viscosity fluid promotes fracture complexity by increasing the created fracture surface area and by increasing the fracture density in the reservoir. Under these specific reservoir conditions, the impact of fluid viscosity is very significant. FIG. 4 illustrates the evolution of stimulated surface area—that is, when transmissivity of NFs and HFs exceeds 2 mD-ft (6×10⁻¹⁶ m³)—for 3 viscosity cases: 0.03, 1, and 80 cp, respectively. At shut-in, between 20 and 120 minutes, stimulation still occurs as NFs and HFs are still dilated as the fluid pressure and fluid spread through the network. From these results, low-viscosity fluids access more of the reservoir.

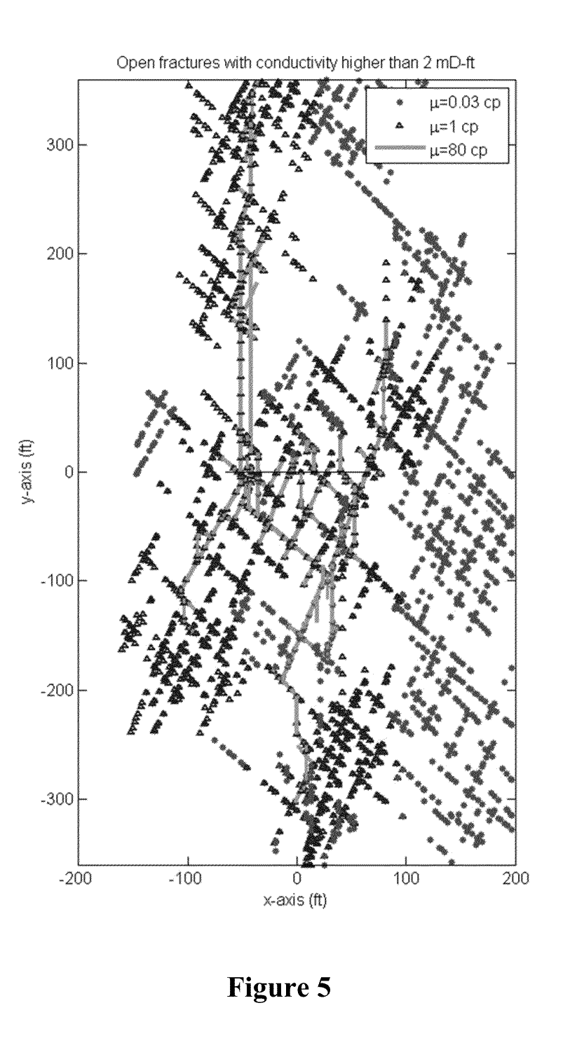

Low-viscosity fluids tend to dilate a higher fraction of NFs (thereby increasing fracture density) during pumping and shut-in. FIG. 5 represents a superimposed cross plot of fractures with residual transmissivity of at least 2 mD-ft (6×10⁻¹⁶ m³) for all three viscosity cases at 120 minutes (20 minutes pumping and 100 minutes shut-in). FIG. 5 illustrates that low-viscosity fluids stimulate a higher density of reservoir area per unit volume of reservoir.

The fracturing fluid also leads to increased fracture network complexity as well as enhanced flowback and enhanced oil recovery benefits. With these fluids, fracture initiation via breakdown can occur at lower pressures, and pressure may be extended deeper in the reservoir matrix under dynamic conditions. Using these fluids can also help mitigate damage to narrow fractured pathways due to having a viscosity lower than the viscosity of water and general miscibility with reservoir hydrocarbons. The stimulated reservoir area generated from the ultra-low viscosity fluid will not have the inherent formation damage properties of slickwater and gelled fluid from insoluble residues or macromolecules. The ultra-low viscosity fluid also has less viscosity than slickwater (by as much as a factor of 10) and, thus, has far less resistance to unload from the stimulated area during production. The ultra-low viscosity fluid may be miscible with formation fluids, which promotes the onset of production. In contrast, interfacial tension between slickwater/aqueous gelled fluid and formation fluids resist onset of production in some stimulated areas. The ultra-low viscosity fluid generates more producible stimulated reservoir area than slickwater in terms of generated surface area and causes less damage to the stimulated area.

In a conventional method, a fracturing process involves at least four steps. First, an acid breakdown fluid is injected into the formation to clean up the formation directly adjacent to the well bore. In addition, this treatment weakens the rock so that the breakdown pressure is not too high. Second, the formation is fractured by injecting a pad fluid into the formation. Third, a fracturing fluid is injected to introduce proppant into the formation. Fourth, a flushing fluid is injected into the formation to recover the treatment fluids using in the fracturing process from the formation. All of these treatment fluids typically include thousands of gallons of fresh water.

In contrast, in the present method, a fluid having a viscosity lower than the viscosity of water is injected into the formation, which may replace one or both of the acid breakdown fluid and the pad fluid from conventional methods. Thus, by using a fluid having a viscosity lower than the viscosity of water, the present method may reduce the number of steps and the amount of freshwater needed in the fracturing process. In the alternative, the acid breakdown fluid can still be used, and the fluid having a viscosity lower than the viscosity of water can replace the pad fluid for the purpose of formation breakdown. Regardless, the fluid having a viscosity lower than the viscosity of water cannot carry proppant effectively. As such, an additional step is needed, which involves injecting a conventional fluid into the formation in order to carry proppant for the purpose of generating conductivity near the wellbore. As a final step, the flushing fluid of conventional methods may be replaced with the same fluid of the first step, a fluid having a viscosity lower than the viscosity of water. Prior to the present invention, such a method has never been used or contemplated for recovering hydrocarbons from a hydrocarbon-bearing subterranean formation having a matrix permeability of less than 1 mD, less than 0.1 mD, or less than 1 μD.

Subterranean formations are located between overburden and underburden, which largely act as seals or flow inhibitors/barriers. The subterranean formation can, among other things, contain siliciclastics and carbonate rocks, clay, minerals, hydrocarbons, and organic material within the formation materials thereof. The formation materials included in the present technology are those found in geologic formations such as tight reservoirs. Such formation materials include, but are not limited to, formations of rock and shale, which include hydrocarbons interspersed amongst the inorganic components.

As discussed above, one method of the present invention includes injecting a fluid having a viscosity lower than the viscosity of water into a hydrocarbon-bearing subterranean formation. In one embodiment, the fluid having a viscosity lower than the viscosity of water is injected through a well into a subterranean formation containing hydrocarbons, the ultra-low viscosity fluid is allowed to reside for a period of time in the subterranean formation, and oil is subsequently produced from the subterranean formation.

The ultra-low viscosity fluid can be left to reside in the subterranean formation, for instance, for at least three hours before additional fluid is added, further pumping begins, or the fluid is recovered. In additional embodiments, the ultra-low viscosity fluid is allowed to reside for one to three days, two to three weeks, or one to two months. The amount of time that the ultra-low viscosity fluid resides in the subterranean formation will depend on a number of factors such as the size of the formation, the type of formation, the initial fluid distribution, the petrophysical characteristics of the formation, the applied drawdown, and the wellbore configuration.

The injection process may be cyclic or continuous. If cyclic, cycles which include both the injection and production durations may last one week. In additional embodiments, cycles, which include both the injection and production durations may last one to two months or one to two years.

The injection of the ultra-low viscosity fluid and subsequent oil recovery may be in the same well or different wells.

The porosity of the reservoir is involved in determining the volume of liquid needed, location of the wells, and recognition of the effects obtainable with the present method. The term porosity refers to the percentage of pore volume compared to the total bulk volume of a rock. A high porosity means that the rock can contain more oil per volume unit. The saturation levels of oil, gas, and water refer to the percentage of the pore volume that is occupied by oil or gas. An oil saturation level of 20% means that 20% of the pore volume is occupied by oil, while the rest is gas or water.

During oil extraction, the pore content may change due to production or other parameters affecting the reservoir. In the present method, the fluid is injected into a subterranean formation and resides in the pore space for a period of time to release oil from the pore spaces.

The injection pressure for injecting the fluids of the present invention is preferably above the initial reservoir pressure but is not required to be above the initial reservoir pressure.

In low-permeability formations, the goal of hydraulic fracturing is to form long, high surface area fractures that greatly increase the magnitude of the pathway of fluid flow from the formation to the wellbore. In this regard, the fluid having a viscosity lower than the viscosity of water generates a greater fractured surface area per volume of the formation and per volume of fluid pumped than aqueous systems. The fluid having a viscosity lower than the viscosity of water also achieves a higher leakoff contrast (natural fracture leakoff/bulk leakoff) than water. In other words, the ultra-low viscosity fluid exhibits minimum matrix leak-off but relatively high natural fracture leakoff, which leads to a larger and denser fractured area. As such, the ultra-low viscosity fluid can stimulate large surface areas, and most of this area will contribute significantly as potential producible pathways due to lower flow resistances in tight channels. The combined use of the fluid having a viscosity lower than the viscosity of water and a conventional fluid creates fracture complexity deep in the formation but can also carry proppant in the vicinity of the wellbore for near-wellbore conductivity. This combined use also reduces damage to narrow fractured pathways due to the low viscosity and general miscibility with the hydrocarbons.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of recovering hydrocarbons from a hydrocarbon-bearing subterranean formation with a matrix permeability of less than 1 mD, comprising:
injecting a volume of a first fluid having a viscosity lower than the viscosity of water into an injection well present in the formation;
separately injecting a volume of a second fluid into the formation before, after, or before and after injecting the first fluid; and
producing at least a fraction of the injected volume of the first fluid and hydrocarbons from the formation through a production well present in the formation.

2. The method of claim 1, wherein the first fluid is pure or substantially pure carbon dioxide.

3. The method of claim 1, further comprising:
flushing the formation with the first fluid after the second fluid is injected.

4. The method of claim 1, wherein the second fluid carries proppant.

5. The method of claim 1, wherein the second fluid is a gelled aqueous fluid, foam, or emulsion.

6. The method of claim 1, further comprising fracturing a portion of the hydrocarbon-bearing subterranean formation.

7. The method of claim 4, wherein the proppant is at least one selected from the group consisting of nut shells, resin-coated nut shells, graded sand, resin-coated sand, sintered bauxite, particulate ceramic materials, glass beads, and particulate polymeric materials.

8. The method of claim 6, wherein the hydrocarbon-bearing subterranean formation has a matrix permeability of less than 0.1 mD.

9. The method of claim 6, further comprising the step of permitting the injected volume of the first fluid to reside for a period of time in the formation before said at least a fraction of the injected volume of the first fluid and the hydrocarbons are produced from the formation.

10. The method of claim 6, wherein the steps of injecting are cyclic or continuous.

11. The method of claim 6, wherein the injected volume of the first fluid is injected continuously into a first injection well in fluid communication with the formation; and
wherein hydrocarbons are produced from a second production well in fluid communication with the formation.

12. The method of claim 1, wherein the volume of fluid for each injection is 1 to 100,000 barrels.

13. The method of claim 1, wherein the first fluid carries proppant of 100 mesh or smaller.

14. A fracturing fluid, comprising:
a first fluid having a viscosity lower than the viscosity of water; and
a second fluid;
wherein the fracturing fluid is formed after the first fluid and the second fluid have been separately injected into a hydrocarbon-bearing subterranean formation with a matrix permeability of less than 1 mD.

15. The fracturing fluid of claim 14, wherein the first fluid is pure or substantially pure carbon dioxide.

16. The fracturing fluid of claim 14, wherein the second fluid is a gelled aqueous fluid, foam, or emulsion.

17. A method of restimulating a hydrocarbon-bearing subterranean formation with a matrix permeability of less than 1 mD, comprising:
injecting a volume of a first fluid having a viscosity lower than the viscosity of water into an injection well present in the formation;
separately injecting a second fluid into the formation before, after, or before and after injecting the first fluid; and
producing at least a fraction of the injected volume of the first fluid and hydrocarbons from the formation through a production well present in the formation.

18. The method of claim 17, wherein the first fluid is pure or substantially pure carbon dioxide.

19. The method of claim 17, wherein restimulating the hydrocarbon-bearing subterranean formation comprises fracturing a portion of the hydrocarbon-bearing subterranean formation.

20. The method of claim 19, wherein the hydrocarbon-bearing subterranean formation has a matrix permeability of less than 0.1 mD.

21. The method of claim 17, wherein the volume of fluid for each injection is 1 to 100,000 barrels.

22. A hydrocarbon recovery system, comprising:
a well connected to a hydrocarbon-bearing subterranean formation with a matrix permeability of less than 1 mD;
an injection apparatus connected to said well;
at least two storage containers in fluid communication with the injection apparatus;
wherein said at least one storage container contains a volume of a first fluid having a viscosity lower than the viscosity of water;
wherein said at least one storage container further contains a separate storage container containing a second fluid; and
at least one valve that only allows one fluid to be injected into said well at a time.

23. The hydrocarbon recovery system according to claim 22, further comprising a second well in fluid communication with the formation for recovering hydrocarbons from the formation.

24. The hydrocarbon recovery system according to claim 22, wherein the first fluid is pure or substantially pure carbon dioxide.

25. The hydrocarbon recovery system according to claim 22, wherein the hydrocarbon-bearing subterranean formation has a matrix permeability of less than 0.1 mD.
